(19) United States
(12) Patent Application Publication
(10) Pub. No.: US 2011/0167062 A1
(43) Pub. Date: Jul. 7, 2011

(54) DOCUMENT SEARCH APPARATUS, METHOD OF CONTROLLING OPERATION OF SAME, AND CONTROL PROGRAM THEREFOR

(75) Inventor: Shunichiro NONAKA, Tokyo (JP)

(73) Assignee: FUJIFILM CORPORATION, Tokyo (JP)

(21) Appl. No.: 12/979,282

(22) Filed: Dec. 27, 2010

(30) Foreign Application Priority Data
Jan. 6, 2010 (JP) 2010-001215

(51) Int. Cl. G06F 17/30

(52) U.S. Cl. 707/728; 707/E17.044

(57) ABSTRACT

Portions within a document that relate to a plurality of keywords are found. Specifically, a plurality of keywords are input and paragraphs containing at least two of the keywords among the input plurality of keywords are found from a document. An overall score of scores is calculated for every paragraph in such a manner that the shorter the space between keywords contained in a paragraph, the higher the score. The paragraphs are displayed in order of decreasing overall score.

### BACKGROUND OF THE INVENTION

1. Field of the Invention

This invention relates to a document search apparatus, a method of controlling the operation of this apparatus and a control program.

2. Description of the Related Art

A search engine allows input of a plurality of keywords and is capable of finding a web page that contains the input plurality of keywords. However, no consideration has been given to finding portions related to a plurality of keywords from within a document file by using a search engine. Further, there is a technique for specifying locations at which a plurality of keywords exist within a fixed character interval (Japanese Patent Application Laid-Open No. 2008-71337) and a technique for displaying search results in order in accordance with the degree of relevancy between keywords (Japanese Patent Application Laid-Open No. 2001-109766).

However, portions relating to a plurality of keywords within a document cannot be found.

### SUMMARY OF THE INVENTION

An object of the present invention is to find portions relating to a plurality of keywords within a document.

A document search apparatus according to the present invention comprises: a keyword input device (keyword input means) for inputting a plurality of keywords; a paragraph detecting device (paragraph detecting means) for finding paragraphs from within a document represented by a document file, the paragraphs each containing at least two keywords among the plurality of keywords that have been input from the keyword input device; a score calculating device (score calculating means) for calculating a score which represents degree of relevancy between each paragraph found by the paragraph detecting device and the plurality of keywords that have been input from the keyword input device, wherein the shorter the space between keywords contained in a paragraph, the higher the score; and a suitability notification device (suitability notification means) for notifying of positions of the paragraphs, which have been detected by the paragraph detecting device, in the document in order of decreasing score calculated by the score calculating device.

The present invention also provides an operation control method suited to the document search apparatus described above. Specifically, the present invention provides a method of controlling operation of a document search apparatus, comprising the steps of: inputting a plurality of keywords; finding paragraphs from within a document represented by a document file, the paragraphs each containing at least two keywords among the plurality of keywords that have been input; calculating a score which represents degree of relevancy between each paragraph found and the plurality of keywords that have been input, wherein the shorter the space between keywords contained in a paragraph, the higher the score; and notifying of positions of the detected paragraphs in the document in order of decreasing score calculated.

The present invention further provides a storage medium storing a computer-readable program for implementing the above-described method of controlling operation of a document search apparatus. It may be so arranged that the program is provided.

In accordance with the present invention, a plurality of keywords are input. Paragraphs each containing two or more keywords among the plurality of input keywords are found from within a document represented by a document file. A score representing the degree of relevancy between each paragraph found and the plurality of input keywords is calculated. The shorter the space between keywords, the higher the score. Notification is given of the positions of the paragraphs in the document in order of decreasing score calculated. Thus, paragraphs relating to a plurality of input keywords can be found from within a document.

By way of example, the score calculating device calculates scores, the values of which are higher the shorter the space between the keywords constituting sets of the keywords, with regard to all sets of the keywords contained in the paragraphs, and calculates an overall score which is a sum of the scores calculated. In this case, by way of example, the notification device notifies of positions of the detected paragraphs in the document in order of decreasing overall score calculated by the score calculating device.

The score calculating device calculates one or more scores, the values of which are higher the shorter the space between the keywords constituting sets of the keywords, with regard to all sets of the keywords contained in the paragraphs, and calculates an overall score which is a product of all of the scores calculated. In this case, by way of example, the notification device notifies of positions of the detected paragraphs in the document in order of decreasing overall score calculated by the score calculating device.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the electrical configuration of a document search apparatus;

FIG. 2 is a flowchart illustrating processing executed by the document search apparatus;

FIG. 3 illustrates part of a document;

FIGS. 4 and 5 are examples of search box images;

FIG. 6 illustrates part of a document;

FIG. 7 is a graph illustrating a function for calculating a score;

FIG. 8 illustrates the manner in which portions of paragraphs are displayed in order of decreasing overall score; and

FIG. 9 is a graph illustrating a function for calculating a score.

### DESCRIPTION OF THE PREFERRED EMBODIMENT

A preferred embodiment of the present invention will be described with reference to the drawings.

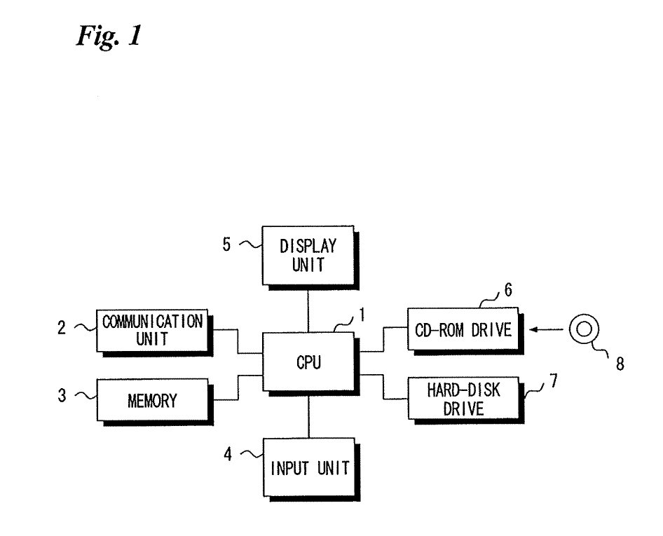

FIG. 1 is a block diagram illustrating the electrical configuration of a document search apparatus according to a preferred embodiment of the present invention.

The document search apparatus receives a plurality of keywords input thereto and finds portions relating to the input plurality of keywords from within a document represented by a document file.

The overall operation of the document search apparatus is controlled by a CPU 1.

The document search apparatus includes a communication unit 2 for communicating with another computer apparatus via the Internet or the like; a memory 3 for storing prescribed data and the like; an input unit (keyboard and mouse, etc.) 4 for inputting a plurality of keywords; a display unit 5; a CD-ROM (Compact Disk-Read Only Memory) drive 6; and a hard-disk drive 7 for accessing a hard disk (not shown).

The CD-ROM 8 stores a program for controlling operation described below. The program recorded on the CD-ROM 8 is read by the CD-ROM drive 6 and installed in the document search apparatus, as a result of which the document search apparatus operates as set forth below. The operation program may be pre-installed in the document search apparatus without being read from the CD-ROM 8 or may be transmitted to the apparatus via the Internet.

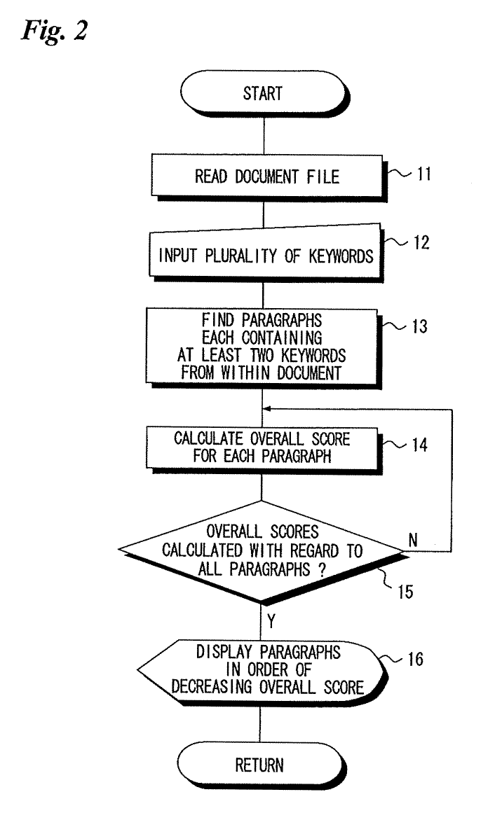

FIG. 2 is a flowchart illustrating processing executed by the document search apparatus.

If a plurality of keywords have been input, the document search apparatus according to this embodiment finds paragraphs relating to these plurality of keywords from within a document represented by a document file.

When a document file representing a document in which paragraphs relating to a plurality of keywords are to be found is designated by the user using the input unit 4, the document file is read from the hard disk and is input to the memory 3 (step 11).

Naturally, the document file may be transmitted from another computer or the like via the communication unit 2 without being recorded on the hard disk.

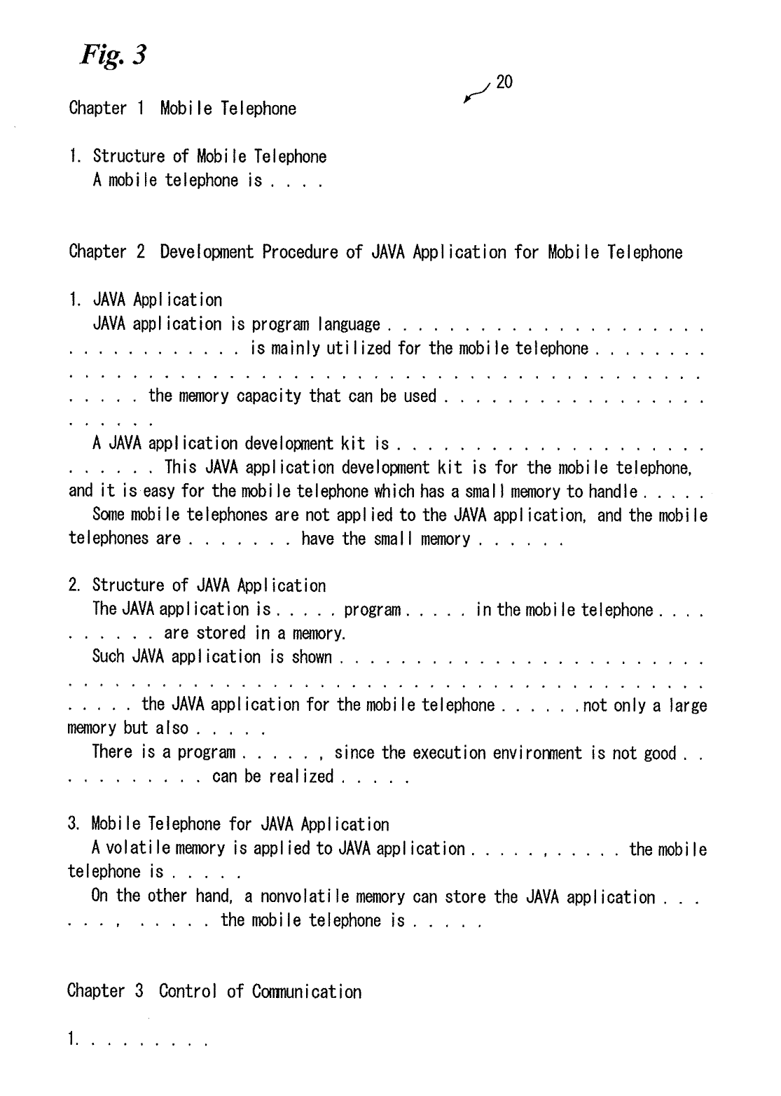

FIG. 3 illustrates part of a document represented by the document file designated by the user.

A document file representing a document 20 has been developed in the memory 3. Although the document 20 is not displayed on the display screen of the display unit 5 at this time, it may be so arranged that the document is displayed.

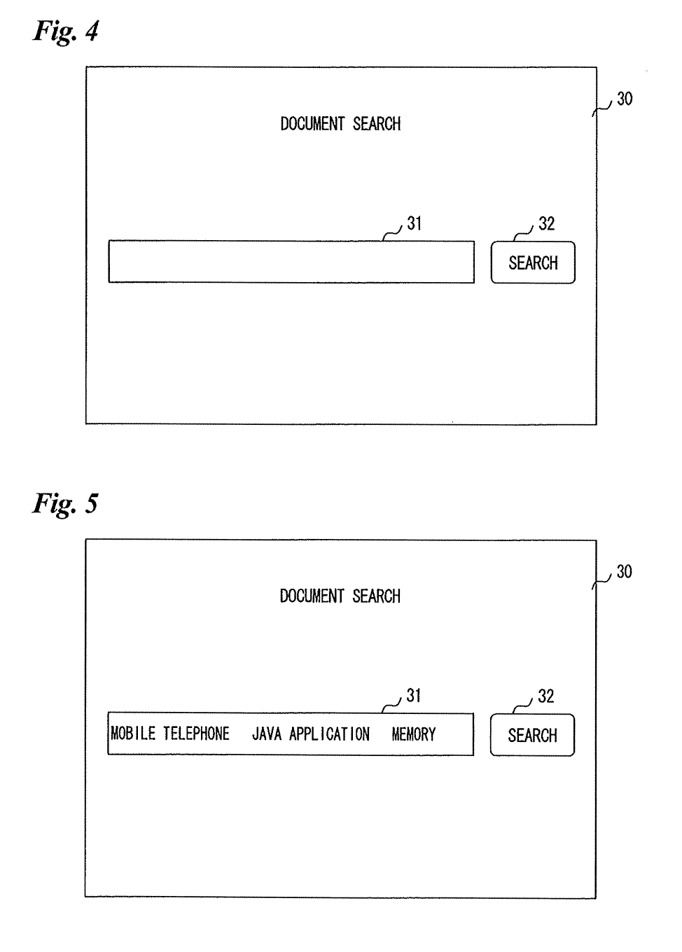

A search box image shown in FIG. 4 is displayed on a display screen 30 of the display unit 5.

A keyword input area 31 is formed at substantially the central portion of the search box image. The keyword input area 31 is an area that displays keywords that have been input from the input unit 4. A search command area 32 is formed on the right side of the keyword input area 31. The search command area 32 is clickable. By clicking the search command area 32, the document search apparatus is supplied with a search command for finding paragraphs, which relate to keywords (input keywords) being displayed in the keyword input area 31, from the document 20.

FIG. 5 is an example of a search box image in a case where a plurality of keywords have been input using the input unit 4.

In this embodiment, it is assumed that three keywords, namely “mobile telephone”, “JAVA application” and “memory” have been input using the input unit 4. It goes without saying that as long as a plurality of keywords are input, it does not matter whether two or four or more keywords have been input. The keywords “mobile telephone”, “JAVA application” and “memory” that have been input by the user are displayed in the keyword input area 31. The keywords “mobile telephone”, “JAVA application” and “memory” are spaced apart in such a manner that the document search apparatus can recognize that they are different keywords. A continuous character string devoid of a space will be recognized as a single keyword by the document search apparatus.

With reference again to FIG. 2, a plurality of keywords are input by the user (step 12) and the search command area 32 is clicked, whereby a search command is applied to the document search apparatus. When this occurs, the apparatus starts executing search processing regarding the document 20.

First, paragraphs containing at least two keywords among the input plurality of keywords are found from within the document 20 (step 13). Naturally, it may be so arranged that paragraphs that do not contain at least two keywords but only one keyword or keywords that are 50% or more of the input keywords are found from within the document 20. A paragraph is found with a line feed command or a portion where the beginning of text is indented by one character serving as the beginning and end of the paragraph.

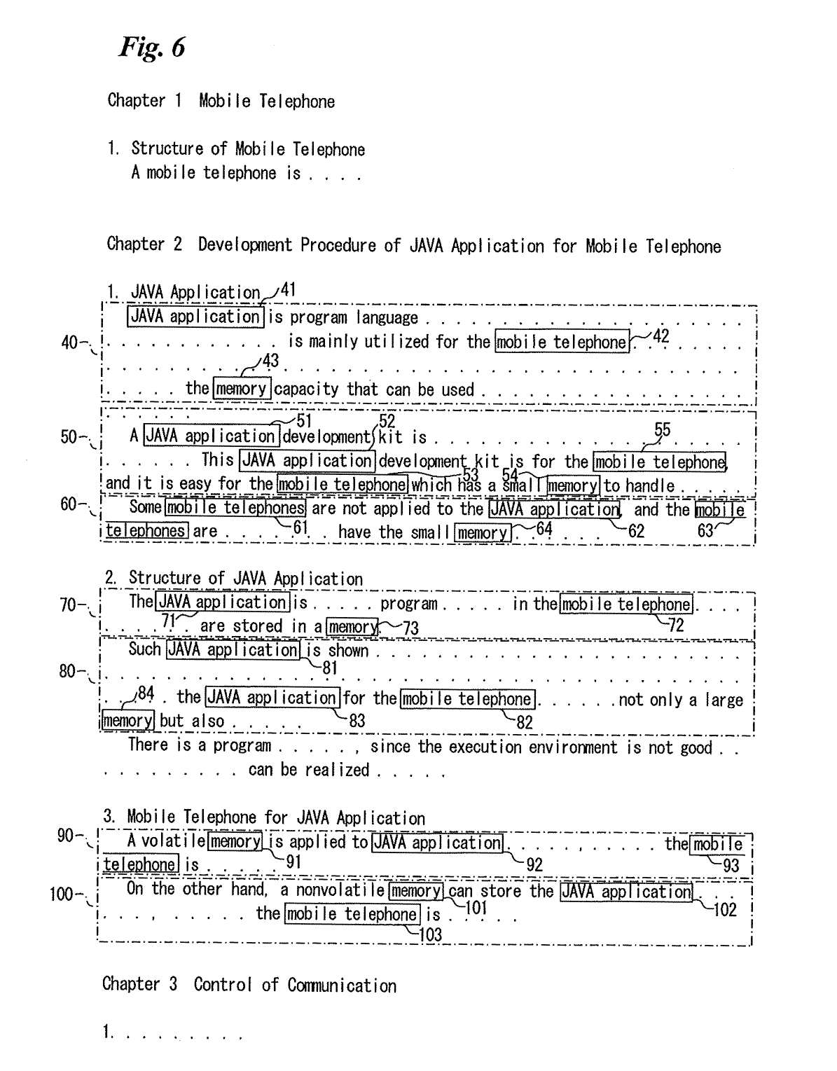

FIG. 6 illustrates part of the above-mentioned document 20 and also shows paragraphs that have been found.

It will be assumed that paragraphs 40, 50, 60, 70, 80, 90 and 100 have been found as paragraphs containing at least two keywords. The paragraph 40 contains keywords 41 to 43 corresponding to any of the keywords among the input plurality of keywords. The paragraphs 50, 60, 70, 80, 90 and 100 similarly contain keywords 51 to 55, 61 to 64, 71 to 73, 81 to 84, 91 to 93 and 101 to 103, respectively.

Thus, paragraphs containing at least two keywords among the input plurality of keywords are found from within the document 20.

With reference again to FIG. 2, an overall score indicating the degree of the relationship between a paragraph and the input plurality of keywords is calculated with regard to each of the paragraphs that have been found (step 14).

In order to calculate the overall score for every paragraph in this embodiment, a score, the value of which is higher the shorter the space between keywords contained in the paragraph, is calculated. The sum of the calculated scores serves as the overall score of the paragraph.

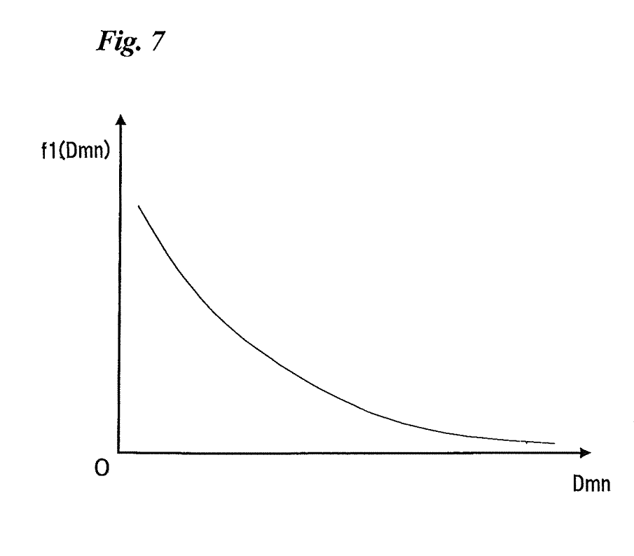

FIG. 7 illustrates the graph of a function f1(Dmn) for calculating a score the value of which is higher the shorter the space between keywords contained in a paragraph.

In a case where the distance between an mth keyword and an nth keyword among the input plurality of keywords (where the number of characters that exists between the mth and nth keywords, m and n are positive integers) is Dmn, the function f1(Dmn) is such that the shorter the distance Dmn, the higher the value of the function, and the longer the distance Dmn, the more the value of the function approaches zero. The value of the function f1(Dmn) is the score which becomes higher as the space between keywords shortens, as mentioned above. The sum total of the scores is calculated for every paragraph in accordance with Equation (1) below. The sum total for every paragraph calculated in accordance with Equation (1) is the above-mentioned overall score.

S=Σ_{m,n;mn}ƒ1(Dₘₙ) Eq. (1)

With reference to FIG. 6, in paragraph 40 the score of keywords 41 and 42, the score of keywords 41 and 43 and the score of keywords 42 and 43 are calculated. The sum total of these three scores is calculated in accordance with Equation (1) to thereby calculate the overall score. The scores of keywords are calculated in the other paragraphs 50, 60, 70, 80, 90 and 100 as well and the overall score is calculated for every paragraph.

In a case where an overall score is calculated in accordance with Equation (1) (a case where a score is calculated in accordance with the graph of FIG. 7), the score is zero with regard to a keyword among the input plurality of keywords that is not contained in a detected paragraph, and the keyword has no effect upon Equation (1) (the keyword can be neglected). An overall score corresponding to human perception, therefore, can be calculated.

With reference again to FIG. 2, overall-score calculation processing is repeated (step 15) until overall scores are calculated as described above with regard to all paragraphs that have been detected as paragraphs containing at least two keywords. When overall scores are calculated with regard to all detected paragraphs (“YES” at step 15), the detected paragraphs are displayed on the display screen of the display unit 5 in order of decreasing overall score.

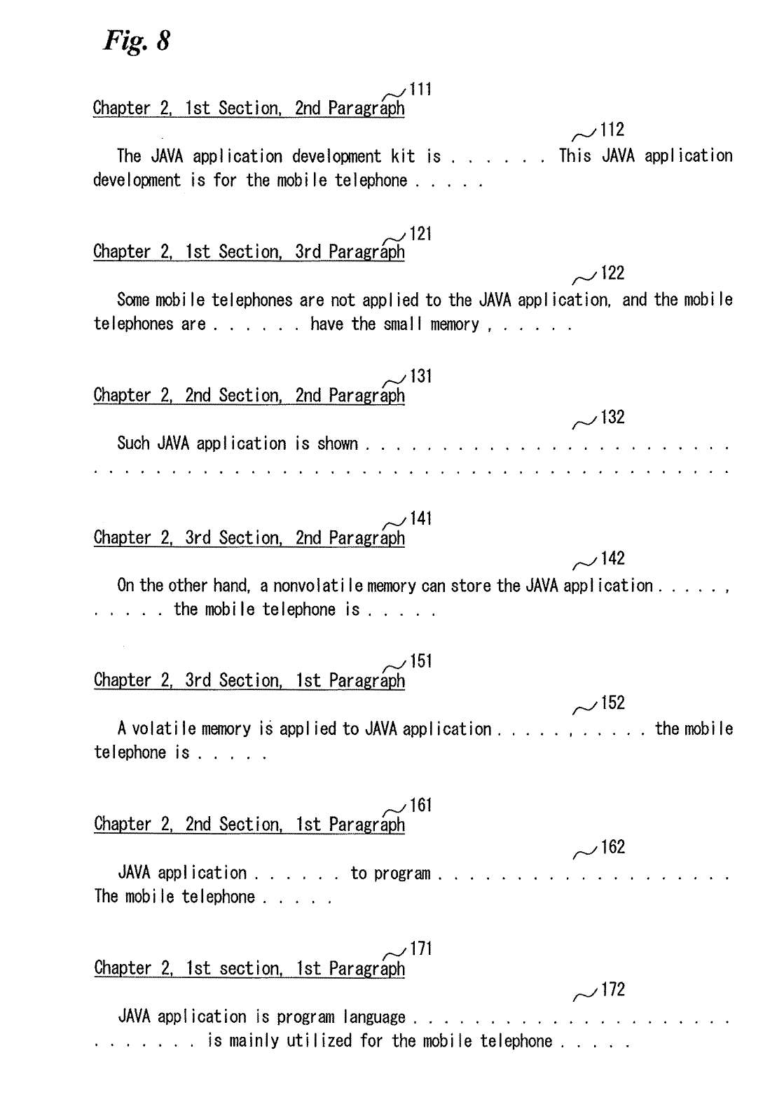

FIG. 8 illustrates the manner in which detected paragraphs are displayed in order of decreasing overall score.

Assume that the paragraphs are ranked as follows in order of decreasing overall score: paragraphs 50, 60, 80, 100, 90, 70 and 40. Portions of the paragraphs are displayed in the order of these overall scores. In this embodiment, indices indicating where these paragraphs exist in the document are also displayed in front of the respective paragraphs.

For example, since paragraph 50 having the highest overall score is the second paragraph in the first section of the second chapter of document 20, an index 111 indicating the paragraph is displayed. A portion (or the entirety) 112 of paragraph 50 is displayed starting from the line following the index 111. It may be so arranged that by establishing a link to the index 111 and clicking the index 111, the corresponding paragraph 50 is displayed on the display screen.

Similarly, with regard to the other paragraphs, an index 121 indicating the position of paragraph 60 is displayed, and a portion 122 of paragraph 60 is displayed starting from the line following the index 121. An index 131 of paragraph 80 and a portion 132 of this paragraph 80, an index 141 of paragraph 100 and a portion 142 of this paragraph 100, an index 151 of paragraph 90 and a portion 152 of this paragraph 90, an index 161 of paragraph 70 and a portion 162 of this paragraph 70, and an index 171 of paragraph 40 and a portion 172 of this paragraph 40 are displayed in a similar manner.

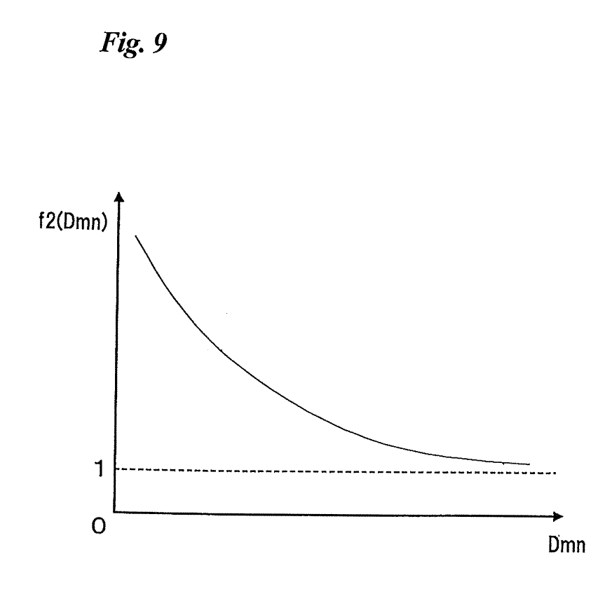

FIG. 9 is a graph illustrating another example of a function for calculating the scores of the keywords.

The function f1(Dmn) shown in FIG. 7 is such that the value is higher the shorter the distance between two keywords within the same paragraph, and the longer the distance, the more the value approaches zero. A function f2(Dmn) shown in FIG. 9, on the other hand, is such that the shorter the distance between two keywords within the same paragraph, the higher the value, and the longer the distance, the more the value approaches unity.

The score of two keywords is calculated based upon the function f2(Dmn). An overall score is calculated for every paragraph in accordance with Equation (2) below.

S=Π_{m,m;m<n}ƒ2(Dₘₙ) Eq. (2)

According to Equation (2), the product of calculated scores is calculated for every paragraph.

In a case where an overall score is calculated in accordance with Equation (2) (a case where a score is calculated in accordance with the graph of FIG. 9), the score is unity with regard to a keyword among the input plurality of keywords that is not contained in a detected paragraph, and the keyword has no effect upon Equation (2) (the keyword can be neglected). An overall score corresponding to human perception, therefore, can be calculated.

In the embodiment described above, a paragraph containing at least two keywords is found from within a document and the overall score regarding the found paragraph is calculated in the manner described above. However, it may be so arranged that even if at least two keywords are not contained in the same paragraph, if two or more keywords are included within a prescribed number of characters (e.g., within 100 characters), then the paragraph in which these keywords are included is detected. Naturally, it may be so arranged that a paragraph in which at least one keyword is included may be detected. An overall score for every paragraph can be calculated utilizing Equation (1) or (2) in these cases as well.

As many apparently widely different embodiments of the present invention can be made without departing from the spirit and scope thereof, it is to be understood that the invention is not limited to the specific embodiments thereof except as defined in the appended claims.

What is claimed is:

1. A document search apparatus comprising:
a keyword input device for inputting a plurality of keywords;
a paragraph detecting device for finding paragraphs from within a document represented by a document file, the paragraphs each containing at least two keywords among the plurality of keywords that have been input from said keyword input device;
a score calculating device for calculating a score which represents degree of relevancy between each paragraph found by said paragraph detecting device and the plurality of keywords that have been input from said keyword input device, wherein the shorter the space between keywords contained in a paragraph, the higher the score; and
a suitability notification device for notifying of positions of the paragraphs, which have been detected by said paragraph detecting device, in the document in order of decreasing score calculated by said score calculating device.

2. The apparatus according to claim 1, wherein said score calculating device calculates scores, the values of which are higher the shorter the space between the keywords constituting sets of the keywords, with regard to all sets of the keywords contained in the paragraphs, and calculates an overall score which is a sum of the scores calculated; and
said notification device notifies of positions of the detected paragraphs in the document in order of decreasing overall score calculated by said score calculating device.

3. The apparatus according to claim 1, wherein said score calculating device calculates one or more scores, the values of which are higher the shorter the space between the keywords constituting sets of the keywords, with regard to all sets of the keywords contained in the paragraphs, and calculates an overall score which is a product of all of the scores calculated; and
said notification device notifies of positions of the detected paragraphs in the document in order of decreasing overall score calculated by said score calculating device.

4. A method of controlling operation of a document search apparatus, comprising the steps of:
inputting a plurality of keywords;
finding paragraphs from within a document represented by a document file, the paragraphs each containing at least two keywords among the plurality of keywords that have been input;
calculating a score which represents degree of relevancy between each paragraph found and the plurality of keywords that have been input, wherein the shorter the space between keywords contained in a paragraph, the higher the score; and
notifying of positions of the detected paragraphs in the document in order of decreasing score calculated.

5. A recording medium storing a computer-readable program for controlling a computer of a document search apparatus so as to:
input a plurality of keywords;
find paragraphs from within a document represented by a document file, the paragraphs each containing at least two keywords among the plurality of keywords that have been input;
calculate a score which represents degree of relevancy between each paragraph found and the plurality of keywords that have been input, wherein the shorter the space between keywords contained in a paragraph, the higher the score for the paragraph; and
notifying of positions of the detected paragraphs in the document in order of decreasing score calculated.
